(19) United States
(12) Patent Application Publication
(10) Pub. No.: US 2020/0147994 A1
(43) Pub. Date: May 14, 2020

(54) HANGING FOLDER ASSEMBLY

(71) Applicant: Christopher Cocco, W. Long Beach, NJ (US)

(72) Inventor: Christopher Cocco, W. Long Beach, NJ (US)

(21) Appl. No.: 16/183,897

(22) Filed: Nov. 8, 2018

(51) Int. Cl. B42F 15/00

(52) U.S. Cl. CPC B42F 15/0035; B42P 2241/10

(57) ABSTRACT

A hanging folder assembly for identifying documents that need attention includes a hanging folder that has a plurality of documents positioned therein for storage. A pocket is coupled to the hanging folder and the pocket has a depth and a width of approximately 9.0 inches for insertably receiving an ANSI Letter size paper. The pocket is oriented on the hanging folder such that the ANSI Letter size paper is oriented perpendicular to the documents in the hanging folder. In this way the pocket identifies the ANSI Letter size paper as needing attention.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to hanging folder devices and more particularly pertains to a new hanging folder device for identifying documents that need attention.

### BRIEF SUMMARY OF THE INVENTION

An embodiment of the disclosure meets the needs presented above by generally comprising a hanging folder that has a plurality of documents positioned therein for storage. A pocket is coupled to the hanging folder and the pocket has a depth and a width of approximately 9.0 inches for insertably receiving an ANSI Letter size paper. The pocket is oriented on the hanging folder such that the ANSI Letter size paper is oriented perpendicular to the documents in the hanging folder. In this way the pocket identifies the ANSI Letter size paper as needing attention.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a hanging folder assembly according to an embodiment of the disclosure.

FIG. 2 is a bottom view of an embodiment of the disclosure.

FIG. 3 is a left side view of an embodiment of the disclosure.

FIG. 4 is a front view of an embodiment of the disclosure.

### DETAILED DESCRIPTION OF THE INVENTION

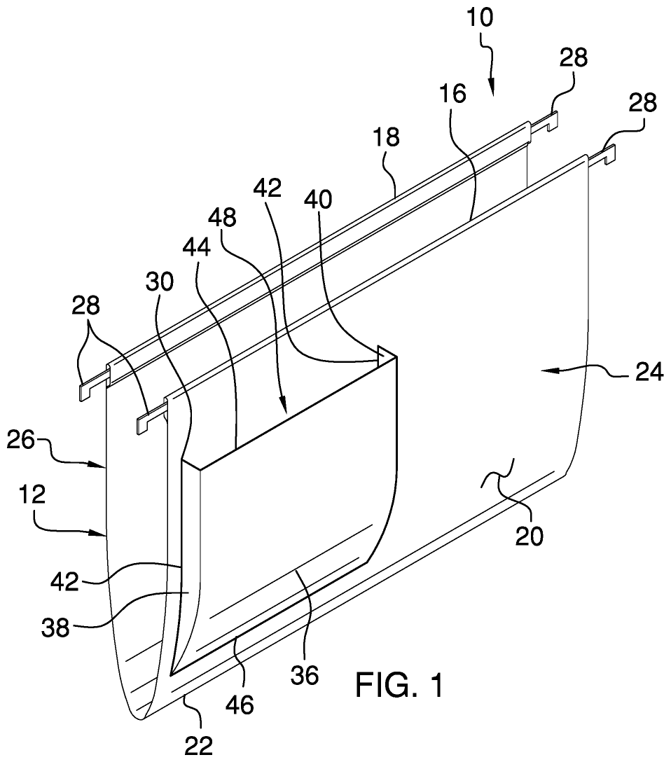

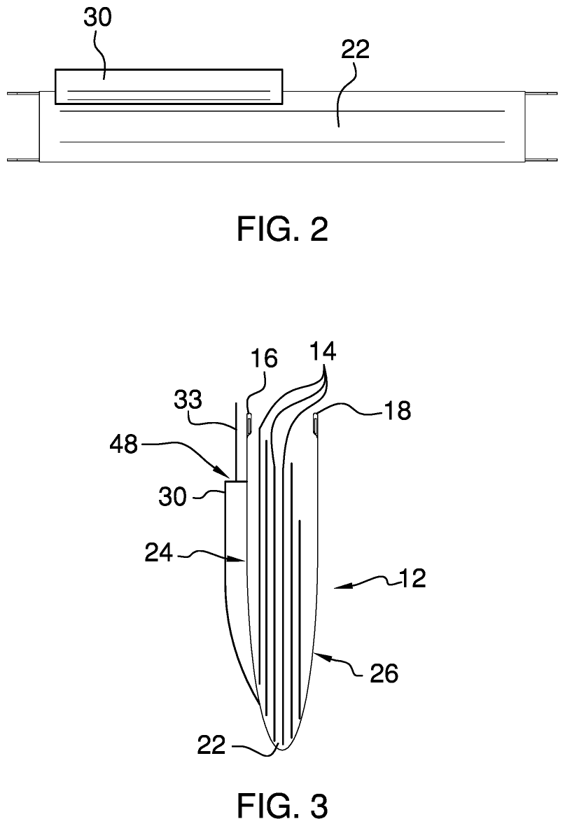

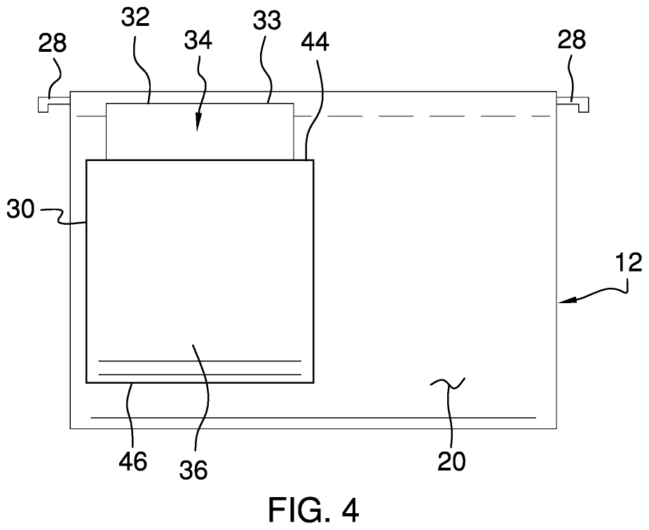

With reference now to the drawings, and in particular to FIGS. 1 through 4 thereof, a new hanging folder device embodying the principles and concepts of an embodiment of the disclosure and generally designated by the reference numeral 10 will be described.

As best illustrated in FIGS. 1 through 4, the hanging folder assembly 10 generally comprises a hanging folder 12 that has a plurality of documents 14 positioned therein for storage. The hanging folder 12 has a first end 16, a second end 18 and an outer surface 20 extending therebetween. Additionally, the hanging folder 12 has a bend 22 between the first 16 and second 18 ends to define a front half 24 of the hanging folder 12 and a back half 26 of the hanging folder 12. The hanging folder 12 has a plurality of engagements 28 thereon to engage a support for suspending the hanging folder 12. The hanging folder 12 may be positioned in a file cabinet or the like for storing and organizing documents 14.

A pocket 30 is coupled to the hanging folder 12 and the pocket 30 has a depth and a width of approximately 9.0 inches for insertably receiving an ANSI Letter size paper 32. The pocket 30 is oriented on the hanging folder 12 such that the ANSI Letter size paper 32 is oriented perpendicular to the documents 14 in the hanging folder 12. In this way the pocket 30 identifies the ANSI Letter size paper 32 as a document needing attention 33. Additionally, the pocket 30 facilitates an upper portion 34 of the ANSI Letter size paper 32 to be visible thereby facilitating the ANSI Letter size paper 32 to be identified.

The pocket 30 has a front wall 36, a first lateral wall 38 and a second lateral wall 40, and each of the first 38 and second 40 lateral walls has a distal edge 42 with respect to the front wall 36. The front wall 36 has an upper edge 44 and a lower edge 46. Additionally, each of the lower edge 46 and the distal edge 42 of each of the first 38 and second 40 lateral walls is coupled to the outer surface 20 of the front half 24 of the hanging folder 12. Moreover, the upper edge 44 is spaced from the outer surface 20 of the front half 24 of the hanging folder 12 to define an opening 48 into the pocket 30. The opening 48 is directed toward the first end 16 of the hanging folder 12 and the pocket 30 may be offset from a center of the front half 24 of the hanging folder 12.

In use, the hanging folder 12 is suspended in the file cabinet or the like for storing documents 14. Any documents, such as the ANSI Letter sized paper 32, requiring attention that are related to the documents 14 in the hanging folder 12 are inserted into the pocket 30. In this way the documents needing attention 33 are not only oriented perpendicular to the documents 14 in the hanging folder 12, but the upper portion 34 of the documents needing attention 33 are visible. In this way the documents needing attention 33 are clearly separated from the documents 14 in the hanging folder 12 and the documents needing attention 33 are positioned to draw attention when the hanging folder 12 is observed. Once the documents needing attention 33 are dealt with in the prescribed manner, the documents needing attention 33 are placed into the hanging folder 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hanging folder assembly comprising:
a hanging folder, said hanging folder having a first end, a second end and an outer surface extending therebetween, said hanging folder having a bend between the first and second ends to define a front half of said hanging folder and a back half of said hanging folder; and
a pocket being coupled directly on said front half, said pocket having a depth and a width of approximately 9.0 inches wherein said pocket is narrower than said hanging folder and configured for insertably receiving an ANSI Letter size paper, said pocket being oriented on said hanging folder such that said pocket is configured for the ANSI Letter size paper being oriented perpendicular to documents in said hanging folder wherein said pocket is configured to identify the ANSI Letter size paper as needing attention.

2. The assembly according to claim 1, wherein:
said hanging folder having a plurality of engagements thereon each being configured to engage a support for suspending said hanging folder.

3. The assembly according to claim 1, wherein
said pocket has a front wall, a first lateral wall and a second lateral wall, each of said first and second lateral walls having a distal edge with respect to said front wall, said front wall having an upper edge and a lower edge, each of said lower edge and said distal edge of each of said first and second lateral walls being coupled to said outer surface of said front half of said hanging folder.

4. The assembly according to claim 3, wherein said upper edge is spaced from said outer surface of said front half of said hanging folder to define an opening into said pocket, said opening being directed toward said first end of said hanging folder.

5. A hanging folder assembly having an integrated exterior pocket wherein said assembly is configured to arranged a plurality of documents into two discrete groups, said assembly comprising:
a hanging folder, said hanging folder having a first end, a second end and an outer surface extending therebetween, said hanging folder having a bend between the first and second ends to define a front half of said hanging folder and a back half of said hanging folder, said hanging folder having a plurality of engagements thereon each being configured to engage a support for suspending said hanging folder; and
a pocket being positioned directly on said front half, said pocket having a depth and a width of approximately 9.0 inches wherein said pocket is narrower than said hanging folder and configured for insertably receiving an ANSI Letter size paper, said pocket being oriented on said hanging folder such that said ANSI Letter size paper is oriented perpendicular to documents in said hanging folder wherein said pocket is configured to identify the ANSI Letter size paper as needing attention, said pocket having a front wall, a first lateral wall and a second lateral wall, each of said first and second lateral walls having a distal edge with respect to said front wall, said front wall having an upper edge and a lower edge, each of said lower edge and said distal edge of each of said first and second lateral walls being coupled to said outer surface of said front half of said hanging folder, said upper edge being spaced from said outer surface of said front half of said hanging folder to define an opening into said pocket, said opening being directed toward said first end of said hanging folder.
